(19) United States
(12) Patent Application Publication
(10) Pub. No.: US 2007/0269677 A1
(43) Pub. Date: Nov. 22, 2007

(54) METHOD FOR FORMING A NICKEL-BASED LAYERED STRUCTURE ON A MAGNESIUM ALLOY SUBSTRATE, A SURFACE-TREATED MAGNESIUM ALLOY ARTICLE MADE THEREFROM, AND A CLEANING SOLUTION AND A SURFACE TREATMENT SOLUTION USED THEREFOR

(76) Inventors: Ching Ho, Taipei City (TW); Wei-Te Lee, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/750,949

(22) Filed: May 18, 2007

(30) Foreign Application Priority Data
May 19, 2006 (TW) 095117849

(51) Int. Cl. C22F 1/10; B32B 7/00; B32B 15/01

(52) U.S. Cl. 428/649; 148/527; 428/610

(57) ABSTRACT

This invention relates to a method for forming a nickel-based layered structure and a boundary layer containing a solid solution of magnesium and an M-metal on a magnesium alloy substrate. A surface-treated magnesium alloy article made from the above method, and a cleaning solution and a surface treatment solution used in the above method are also disclosed.

### CROSS-REFERENCE TO RELATED APPLICATION

This application claims priority of Taiwanese Application No. 095117849, filed on May 19, 2006.

### BACKGROUND OF THE INVENTION

1. Field of the Invention

This invention relates to a method for surface treatment of a magnesium alloy substrate, more particularly to a method for forming a nickel-based layered structure on a magnesium alloy substrate. This invention also relates to a surface-treated magnesium alloy article made from the above method, and a cleaning solution and a surface treatment solution used in the above method.

2. Description of the Related Art

Magnesium alloys play an important role in the material industry due to their lightweight and high structural strength properties. However, the magnesium alloys are still unable to be efficiently mass-produced on a large scale due to the necessity and difficulty of surface treatment thereof. First, magnesium and magnesium alloys are chemically active and tend to be corroded by anions in normal atmosphere or under a pH value lower than 10. In the case that a magnesium oxide layer is formed on the magnesium alloys during the corrosion process, the magnesium oxide layer thus formed has a loose structure and is unable to effectively cover the underlying uncorroded magnesium alloys. Second, the hardness of the magnesium alloys is as low as 16 to 40 HRE. When the magnesium alloys are utilized to easily corrodible applications, surface of the magnesium alloys tends to be destroyed and the magnesium alloys are corroded much more severely. Thus, corrosion resistance of the magnesium alloys is relatively poor. Third, magnesium has a hexagonal close-packed (HCP) crystal structure and is difficult to form a solid solution with other metals except for lithium (Li), aluminum (Al), zinc (Zn), zirconium (Zr), and thorium (Th). Thus, it is difficult to form a protective coating having a sufficient thickness on a surface of a magnesium alloy-based article so as to improve the poor corrosion resistance of the magnesium alloys, or to bond the magnesium alloy-based article to other articles.

In order to improve the poor corrosion resistance of the magnesium alloy-based article, U.S. Pat. No. 4,551,211 (hereinafter referred to as the '211 patent) discloses a method for imparting corrosion resistance to an article of magnesium or magnesium-based alloy by anodizing a surface of the article of magnesium or magnesium-based alloy with aluminum hydroxide and the like in an alkali medium. However, since the anodized film formed on the surface of the article is unable to be intimately bonded thereto, the thickness of the anodized film is limited so as to avoid peeling of the anodized film from the article, which results in insufficient toughness and strength for the anodized film.

U.S. Pat. No. 4,770,946 discloses a surface-treated magnesium or magnesium alloy including an anodized film formed on a surface of magnesium or magnesium alloy, a thermosetting resin film formed on the anodized film, and a conductive film formed on the thermosetting resin film through vacuum deposition, ion-plating or sputtering techniques. Similar to the method of the '211 patent, the anodized film formed on the magnesium or magnesium alloy is unable to be intimately bonded thereto. In addition, since the thermosetting resin has an expansion coefficient much higher than that of magnesium or magnesium alloy, the thermosetting resin tends to break after a period of time. As such, longterm corrosion resistance of magnesium or magnesium alloy cannot be ensured.

U.S. Pat. No. 5,683,522 discloses a non-electrolytic process for applying a coating to a magnesium alloy product, involving degreasing the magnesium alloy product, cleaning the magnesium alloy product with a high alkaline solution, deoxidizing the magnesium alloy product, and immersing the magnesium alloy product in a solution containing phosphate, fluoride ions and sodium bifluoride. Similar to the method of the '211 patent, the coating formed on the magnesium alloy product is unable to be intimately bonded thereto. Hence, longterm corrosion resistance of magnesium or magnesium alloy is unavailable.

U.S. Pat. No. 6,787,192 discloses a process for improving corrosion resistance of a magnesium and/or magnesium alloy component. The process includes sequentially treating a magnesium and/or magnesium alloy component with a surface treating agent containing: a phosphate so as to form a first layer on the alloy component; a pre-treating agent containing alkanolamines, or aliphatic amines and the like, so as to form a second layer on the first layer; and a corrosion inhibitor. However, since the first layer formed by application of the surface treating agent contains bonding water, ion migration tends to occur therein, and the first layer is difficult to be intimately bonded to the magnesium and/or magnesium alloy component. In addition, since the second layer is formed by application of a chemical agent containing unstable organic material, longterm corrosion resistance of magnesium and/or magnesium alloy component is unavailable, even though the magnesium and/or magnesium alloy component is treated subsequently with the corrosion inhibitor.

U.S. Pat. No. 6,755,918 discloses a method of treating magnesium alloys with a chemical conversion coating agent containing vanadium oxide or cerium oxide so as to improve corrosion resistance and paint adhesion of the magnesium alloys. However, similar to the method of the '211 patent, the coating formed on the magnesium alloys is unable to be intimately bonded thereto. Hence, longterm corrosion resistance of the magnesium alloys is unavailable.

U.S. Pat. No. 6,669,997 discloses a process for forming an undercoat on an object formed of magnesium or a magnesium alloy assisted by sonication, and then forming a topcoat on the undercoat. The undercoat may be more noble than the topcoat. However, the coating composed of the undercoat and the topcoat is temporarily corrosion-resistant. Since the undercoat is made from a more noble metal, such as copper, the same is difficult to be intimately bonded to the object and tends to react with the magnesium alloy to induce internal micro cell effect. Hence, the corrosion resistance provided by the coating is dramatically reduced, and longterm corrosion resistance of the magnesium alloys is unavailable.

U.S. Pat. No. 6,645,339 discloses silicone compositions including at least one polymerizable silicone component, at least one amine-containing silane adhesion promoter, and at least one filler. The silicone compositions function as an adhesive for bonding a magnesium alloy component to other magnesium alloy components or substrates. However, hardness of the hardened silicone compositions is poor, and the coating formed from the compositions is susceptible to rupture. The coating thus formed is unable to be intimately bonded to the magnesium alloy component. Hence, the magnesium alloy component formed with the coating cannot be efficiently bonded to another magnesium alloy component or substrate, and longterm corrosion resistance of the magnesium alloy component is unavailable.

### SUMMARY OF THE INVENTION

Therefore, there is still a need in the art to provide a method for forming a corrosion-resistant coating on a magnesium or magnesium alloy component in such a manner that the corrosion-resistant coating is firmly bonded to the magnesium or magnesium alloy component, thereby efficiently improving corrosion resistance of the magnesium or magnesium alloy component.

According to one aspect of the present invention, there is provided a method for forming a nickel (Ni)-based layered structure on a magnesium (Mg) alloy substrate, including:

(a) forming a transition layer on the Mg alloy substrate, the transition layer containing Ni crystals and crystals of an M-metal selected from the group consisting of Zn, Co, Cd, and alloys thereof;

(b) forming a first Ni-based layer on the transition layer; and

(c) thermal treating the assembly of the Mg alloy substrate, the transition layer and the first Ni-based layer so as to form a boundary layer containing a solid solution of Mg and the M-metal at an interface between the transition layer and the Mg alloy substrate.

According to another aspect of the present invention, there is provided a surface-treated magnesium alloy article including: a magnesium (Mg) alloy substrate; a boundary layer containing a solid solution of Mg and an M-metal selected from Zn, Co, Cd, and alloys thereof formed on the Mg alloy substrate; and a first nickel-based layer formed on the boundary layer.

According to yet another aspect of the present invention, there is provided a cleaning solution useful for treating a surface of a magnesium alloy article, including: an organic acid selected from the group consisting of lactic acid, acetic acid, oxalic acid, succinic acid, adipic acid, citric acid, malic acid and combinations thereof; an anionic surfactant; and a polar organic solvent.

According to still another aspect of the present invention, there is provided a surface treatment solution including water, fluoride ions, ammonium ions, and nickel ions.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic view to illustrate a magnesium alloy substrate to be treated by the preferred embodiment of a method for forming a nickel-based layered structure on a magnesium alloy substrate according to this invention;

FIG. 2 is a fragmentary schematic view to illustrate a state where residues are formed on the magnesium alloy substrate before a cleaning operation is conducted according to the preferred embodiment of this invention;

FIG. 3 is a fragmentary schematic view to illustrate another state where the residues are removed from the magnesium alloy substrate after the cleaning operation is conducted;

FIG. 4 is a fragmentary schematic view to illustrate formation of a transition layer on the cleaned magnesium alloy substrate according to the preferred embodiment of this invention;

FIG. 5 is a fragmentary schematic view to illustrate formation of a first nickel-based layer on the transition layer according to the preferred embodiment of this invention;

FIG. 6 is a fragmentary schematic view to illustrate reactions of the transition layer with the magnesium alloy substrate and the first Ni-based layer during a thermal treating operation according to the preferred embodiment of this invention;

FIG. 7 is a fragmentary schematic view to illustrate formation of a boundary layer at the interface between the magnesium alloy substrate and the first nickel-based layer according to the preferred embodiment of this invention;

FIG. 8 is a fragmentary schematic view to illustrate formation of a second nickel-based layer on the first nickel-based layer according to the preferred embodiment of this invention; and

FIG. 9 is a fragmentary schematic view to illustrate formation of a third nickel-based layer on the second nickel-based layer according to the preferred embodiment of this invention.

### DETAILED DESCRIPTION OF THE PREFERRED EMBODIMENTS

In one preferred embodiment of a method for forming a Ni-based layered structure on a Mg alloy substrate according to this invention, the method includes the steps of:

(a) forming a transition layer on the Mg alloy substrate, the transition layer containing nickel crystals and crystals of an M-metal selected from the group consisting of Zn, Co, Cd, and alloys thereof;

(b) forming a first Ni-based layer on the transition layer; and

(c) thermal treating the assembly of the Mg alloy substrate, the transition layer and the first Ni-based layer at a temperature sufficient to permit formation of a liquid phase (i.e., a melt) of Mg and the M-metal at an interface between the transition layer and the Mg alloy substrate, followed by cooling the melt so as to form a boundary layer of a solid solution of Mg and the M-metal at the interface.

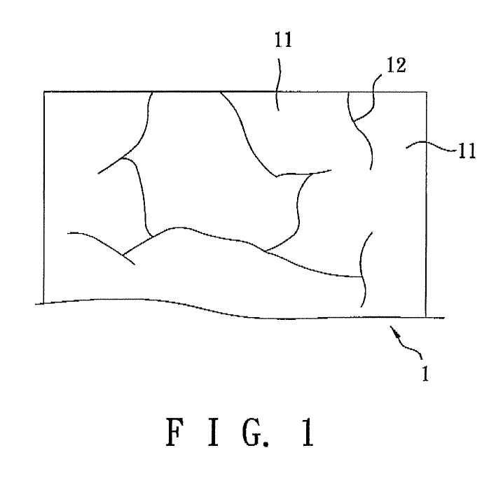

Referring to FIG. 1, in one preferred embodiment, the Mg alloy substrate 1 contains a solid solution 11 of Mg alloy having a texture of a hexagonal closed-packed (HCP) crystal structure, and a plurality of inter-metallic compounds present in grain boundaries 12 of the solid solution 11.

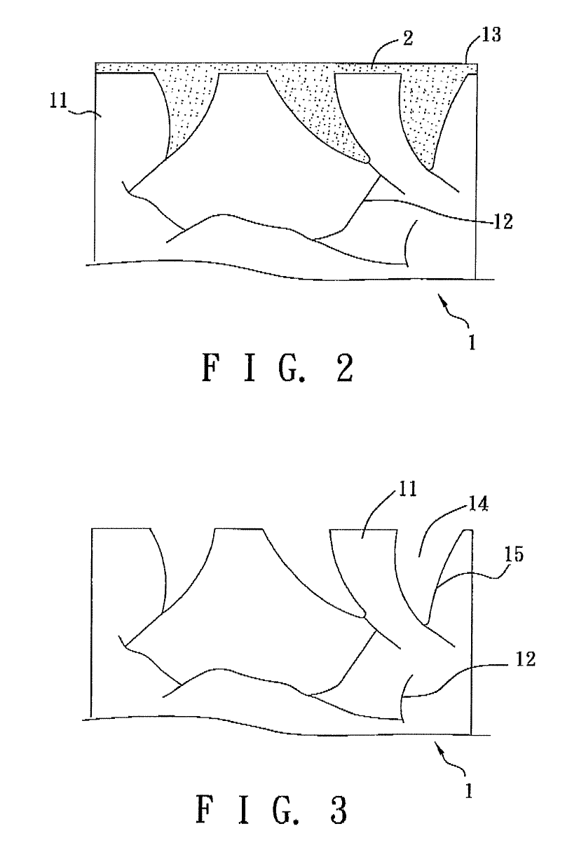

Referring to FIGS. 2 to 5, since the grain boundaries 12 have a loose structure, and since the inter-metallic compounds have relatively high surface energy and tend to result in bonding defects and serious corrosion, preferably, the inter-metallic compounds are at least partially removed so as to form a plurality of recesses 14 in the Mg alloy substrate 1, prior to formation of the transition layer 3 and the first Ni-based layer 4 on the magnesium alloy substrate 1. In another preferred embodiment, the transition layer 3 and the first Ni-based layer 4 extend into the recesses 14 in a manner that the same act like rivets, thereby increasing contact area between the Mg alloy substrate 1 and the transition layer 3 and strengthening bonding strength between the transition layer 3 and the Mg alloy substrate 1.

Preferably, the Mg alloy substrate 1 is cleaned prior to the formation of the transition layer 3 on the Mg alloy substrate 1 in such a manner to expose a texture of a hexagonal closed-packed (HCP) crystal structure on an outer surface 13 of the solid solution 11 of the magnesium alloy substrate 1.

More preferably, the cleaning of the magnesium alloy substrate 1 is conducted by applying a cleaning solution to the Mg alloy substrate 1, and the cleaning solution contains an organic acid, an anionic surfactant, and a polar organic solvent. The cleaning solution reacts with the inter-metallic compounds present in the grain boundaries 12 so as to form into residues 2. Most preferably, the cleaning of the Mg alloy substrate 1 further includes a washing step using a washing solvent to remove the residues 2 from the Mg alloy substrate 1 so as to form the recesses 14 in the Mg alloy substrate 1 and so as to form a substantially residue-free surface 15 of the Mg alloy substrate 1.

Non-limiting examples of the Mg alloy substrate 1 suitable to be treated with the method according to this invention include those made from the stabilized solid solutions 11 of Mg and a metal selected from the group consisting of Al, Zn, Zr, Li, Th, manganese (Mn), and alloys thereof. Commercially available examples of the Mg alloy substrate 1 include but are not limited to AZ31B, AZ61A, ZK60A, LA141A, HM21A, HK31A, and EZ33A. In one preferred embodiment, Mg content in the Mg alloy substrate 1 reaches 83 wt % or more.

The organic acid of the cleaning solution is used for dissolving the inter-metallic compounds present in the grain boundaries 12. Non-limiting examples of the organic acid of the cleaning solution are those selected from the group consisting of lactic acid, acetic acid, oxalic acid, succinic acid, adipic acid, citric acid, malic acid, and combinations thereof. Preferably, the organic acid is lactic acid, and the residues 2 thus formed contain magnesium lactate and lactate of the metal that forms the solid solution 11 with Mg.

The anionic surfactant is used for making hydrophobic molecules more hydrophilic. Non-limiting examples of the anionic surfactant are those selected from the group consisting of sodium lauryl sulfate, sodium iso-alkyl sulfate, sodium lauryl polyvinylether sulfate, sodium glycerol monolaurate sulfate, polyglycerol esters of interesterified ricinoleic acid sodium salt, sodium lauryl sulfonate, 1,2-alkyl phosphate, and combinations thereof. Preferably, the anionic surfactant is selected from the group consisting of sodium lauryl sulfonate, 1,2-alkyl phosphate, and combinations thereof.

In another preferred embodiment, the polar organic solvent contained in the cleaning solution serves to reduce the dissolution rate of the residues 2 dissolved by the organic acid. Consequently, the residues 2 can be retained in the grain boundaries 12 for a certain period of time prior to being washed out, thereby permitting controlling of the dissolution rate of the inter-metallic compounds and of the etching depth into the grain boundaries 12. In one preferred embodiment, the etching depth preferably ranges from 5 to 10 μm. Non-limiting examples of the polar organic solvent are those selected from the group consisting of methanol, ethanol, propanol, isopropanol, and combinations thereof.

In yet another preferred embodiment, the magnesium alloy substrate 1 is made from a solid solution of Mg and Al, and Mg₁₇Al₁₂ ultrafine crystals present in the grain boundaries of the solid solution of Mg and Al; the cleaning solution contains lactic acid, isopropanol, and anionic surfactant; and the residues 2 thus formed contain magnesium lactate and aluminum lactate.

In one preferred embodiment, the concentrations of the organic acid and the anionic surfactant in the cleaning solution range from 0.1 to 2 M and 0.001 to 0.01 M, respectively. More preferably, the concentrations of the organic acid and the anionic surfactant in the cleaning solution range from 0.4 to 0.7 M and 0.002 to 0.004 M, respectively. Most preferably, the concentrations of the organic acid and the anionic surfactant in the cleaning solution range from 0.5 to 0.6 M and 0.0025 to 0.0035 M, respectively.

In another preferred embodiment, the cleaning of the magnesium alloy substrate 1 is assisted by applying an ultrasonic frequency ranging from 300 to 360 KHz to the cleaning solution. The application of the ultrasonic frequency may be conducted by harmonic oscillation techniques at a frequency range selected from one of 300 to 360 kHz, 150-180 kHz and 20-45 kHz.

Alternatively, the cleaning of the magnesium alloy substrate 1 is conducted by applying a first cleaning solution containing the anionic surfactant and the polar organic solvent to the Mg alloy substrate 1 so as to remove hydrophobic molecules on the outer surface 13, and then applying a second cleaning solution containing the organic acid and the polar organic solvent so as to dissolve the inter-metallic compounds.

In one preferred embodiment, the washing solvent is selected from the group consisting of water and an alcohol having a carbon number less than 4. More preferably, the washing solvent is water. In another preferred embodiment, removal of the residues 2 is assisted by applying an ultrasonic frequency ranging from 300 to 360 KHz to the washing solvent. The application of the ultrasonic frequency may be conducted by harmonic oscillation techniques at a frequency range selected from one of 300 to 360 kHz, 150-180 kHz and 20-45 kHz.

In order to further strengthen the structural strength of the transition layer 3 during the thermal treating process, the M-metal 32 contained in the transition layer 3 has an atom radius similar to that of nickel atom. More preferably, the M-metal 32 is Zn.

The transition layer 3 functions as a catalyst layer for formation of the first Ni-based layer 4. Hence, a relatively thick transition layer 3 is not required. In one preferred embodiment, the transition layer 3 has a thickness ranging from 20-200 nm, more preferably, 30-100 nm, and most preferably, 40-60 nm.

In one preferred embodiment, the formation of the transition layer 3 is conducted by applying a transition layer composition to the Mg alloy substrate 1. The transition layer composition includes water, fluoride ions, ammonium ions, M-metal ions, and nickel ions.

In another preferred embodiment, when the M-metal ions are zinc ions, the transition layer composition is maintained at a temperature ranging from 0 to 85° C. and a pH value ranging from 0.1 to 2. The concentrations of the fluoride ions, ammonium ions, zinc ions, and nickel ions respectively range from 0.1-5 M, 0.1-5 M, 0.02-2 M, and 0.05-2 M. More preferably, the transition layer composition is maintained at a temperature ranging from 0 to 30° C. and a pH value ranging from 0.2 to 1.5, and the concentrations of the fluoride ions, ammonium ions, zinc ions, and nickel ions respectively range from 0.7-1.4 M, 0.5-0.9 M, 0.12-0.25 M, and 0.2-0.25 M. Most preferably, the transition layer composition is maintained at a temperature ranging from 20 to 25° C. and a pH value ranging from 0.5 to 1, and the concentrations of the fluoride ions, ammonium ions, zinc ions, and nickel ions respectively range from 0.9-1.2 M, 0.65-0.75 M, 0.16-0.2 M, and 0.22-0.24 M.

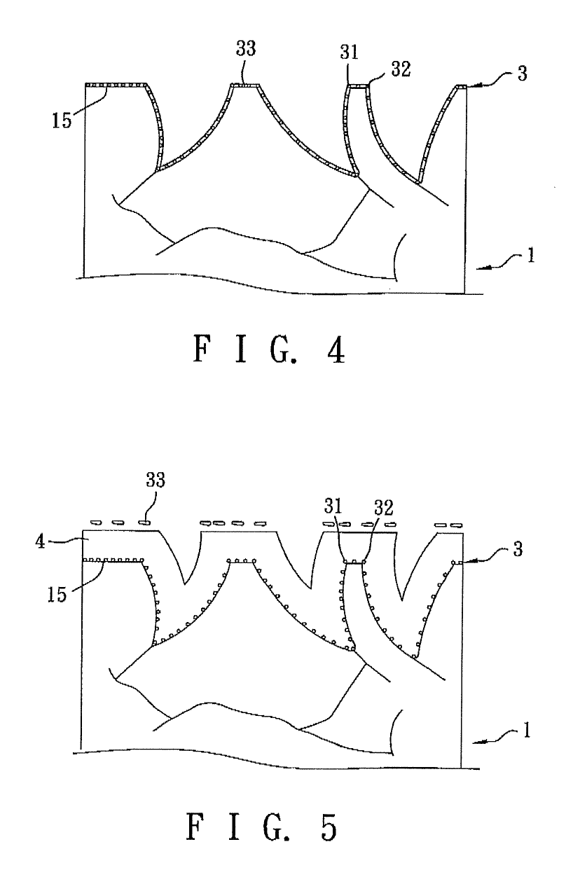

Referring to FIGS. 4 and 5, when the M-metal 32 is Zn, the transition layer 3 formed on the Mg alloy substrate 1 preferably contains Ni crystals 31, Zn crystals 32, and magnesium fluoride (MgF₂) 33. MgF₂ 33 contained in the transition layer 3 is replaced during formation of the first Ni-based layer 4 on the transition layer 3. Hence, a portion of the first Ni-based layer 4 is formed directly on the residue-free surface 15 of the Mg alloy substrate 1.

Preferably, the formation of the first Ni-based layer 4 is controlled so as to partially fill the recesses 14 in the Mg alloy substrate 1. In another preferred embodiment, the first Ni-based layer 4 has a thickness ranging from 2-10 μm, more preferably, 3-8 μm, and most preferably, 4-6 μm.

In yet another preferred embodiment, the formation of the first Ni-based layer 4 is conducted through electroless plating techniques. In still another preferred embodiment, the first Ni-based layer 4 contains nickel and the M-metal 32 as major components and phosphorus (P) as a dopant.

In one preferred embodiment, the formation of the first Ni-based layer 4 is conducted by applying a first Ni-based layer composition to the transition layer 3. The first Ni-based layer composition includes water, fluoride ions, ammonium ions, M-metal ions, nickel ions, hypophosphite ions, and a buffer selected from C2-C8 organic acid ions. That is, the first Ni-based composition is prepared by adding hypophosphite ions and the buffer into the transition layer composition.

In another preferred embodiment, when the M-metal ions are zinc ions, the first Ni-based layer composition is maintained at a temperature ranging from 70 to 100° C. and a pH value ranging from 2 to 6.5. The concentrations of the fluoride ions, ammonium ions, zinc ions, nickel ions, hypophosphite ions, and C2-C8 organic acid ions respectively range from 0.1-5M, 0.1-5 M, 0.02-2 M, 0.02-2 M, 0.05-1 M, and 0.02-2 M. More preferably, the first Ni-based layer composition is maintained at a temperature ranging from 80 to 97° C. and a pH value ranging from 3 to 4.5, and the concentrations of the fluoride ions, ammonium ions, zinc ions, nickel ions, hypophosphite ions, and C2-C8 organic acid ions respectively range from 0.35-0.53 M, 0.35-0.53 M, 0.06-0.09 M, 0.127-0.155 M, 0.1-0.2 M, and 0.07-0.1 M. Most preferably, the first Ni-based layer composition is maintained at a temperature ranging from 90 to 95° C. and a pH value ranging from 3.5 to 4.0, and the concentrations of the fluoride ions, ammonium ions, zinc ions, nickel ions, hypophosphite ions, and C2-C8 organic acid ions respectively range from 0.4-0.5 M, 0.4-0.5 M, 0.07-0.08 M, 0.135-0.145 M, 0.14-0.16 M, and 0.08-0.09 M.

In yet another preferred embodiment, the thermal treating of the assembly of the Mg alloy substrate 1, the transition layer 3 and the first Ni-based layer 4 is conducted at a temperature ranging from 140° C. to 250° C. More preferably, the temperature ranges from 170° C. to 190° C. Most preferably, the thermal treating of the assembly of the Mg alloy substrate 1, the transition layer 3 and the first Ni-based layer 4 is conducted by heating the same to about 180° C. at a heating rate of about 150° C./hr, maintaining this temperature for 60 minutes, and then maintaining at a temperature of about 170° C. to 190° C. for 60 minutes, followed by cooling at a cooling rate of about −150° C./hr to room temperature.

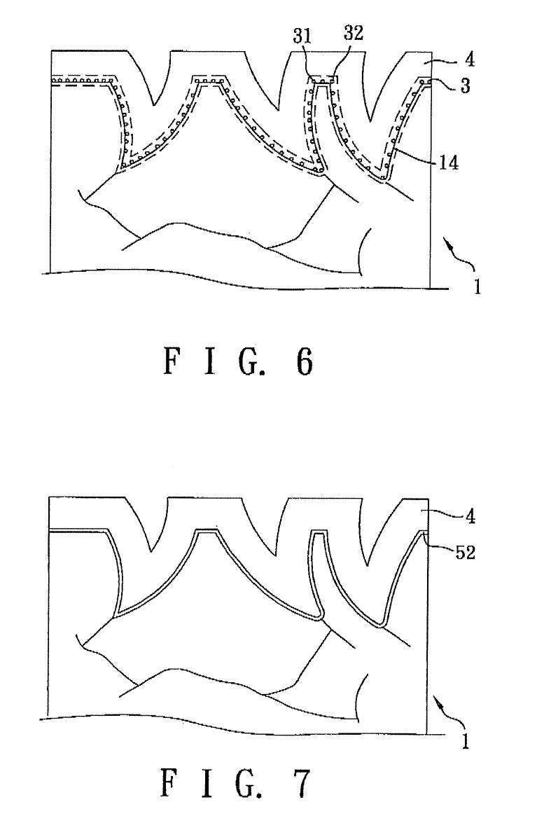

Referring to FIGS. 6 and 7, when the assembly of the Mg alloy substrate 1, the transition layer 3 and the first Ni-based layer 4 is thermal treated so as to form the boundary layer 52, the nickel crystals 31 and the M-metal 32 in the transition layer 3 permeate into the magnesium alloy substrate 1 so as to form a solid solution of Mg and the M-metal 32 at the interface between the transition layer 3 and the Mg alloy substrate 1. In addition, the Ni crystals 31 and the M-metal 32 in the transition layer 3 also permeate into the first Ni-based layer 4 50 as to form a solid solution of Mg and Ni at the interface between the transition layer 3 and the first Ni-based layer 3. Thereafter, the boundary layer 52 is formed. The boundary layer 52 includes the solid solution of Mg and the M-metal 32 thus formed that has a HCP crystal structure. Moreover, an inter-metallic compound of at least two of M-metal 32, Ni, and P is also formed in the boundary layer 52.

In another preferred embodiment, the concentration ratio of Ni to the M-metal 32 in the boundary layer 52 along the layer thickness of the boundary layer 52 is gradually increased from the interface between the boundary layer 52 and the Mg alloy substrate 1 to the interface between the boundary layer 52 and the first Ni-based layer 4. More preferably, for the purpose of intimate bonding of the boundary layer 52 to the Mg alloy substrate 1, the boundary layer 52 has a thickness not less than 20 nm.

In yet another preferred embodiment, the M-metal 32 contained in the boundary layer 52 is Zn, and the boundary layer 52 contains a solid solution of Ni₅₁Zn₂₁ which is disposed adjacent to the first Ni-based layer 4.

More preferably, the concentrations of the ions in the first Ni-based layer composition and the ions in the transition layer composition and the thermal treating temperature are suitably controlled in such a manner that the boundary layer 52 thus formed further includes ultrafine crystals of the M-metal 32 having a hcp crystal structure so as to avoid occurrence of dislocation defects.

In one preferred embodiment, when the M-metal 32 contained in the first Ni-based layer 4 is zinc, the first Ni-based layer 4 thus formed is an amorphous Ni—Zn alloy doped with P, and can be directly welded to other articles through soldering techniques. In another preferred embodiment, when the M-metal 32 contained in the first Ni-based layer 4 is cobalt, the first Ni-based layer is an amorphous Ni-cobalt (Co) alloy doped with P. The first Ni-based layer 4 thus formed has good hardness and low internal stress, in addition to corrosion resistance. Similarly, when the M-metal 32 contained in the first Ni-based layer 4 is Cd, the first Ni-based layer 4 is an amorphous Ni-Cd alloy doped with P. The first Ni-based layer 4 thus formed can also be directly welded to an object through soldering techniques.

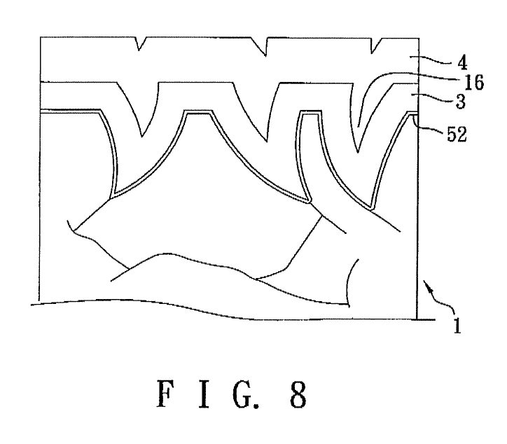

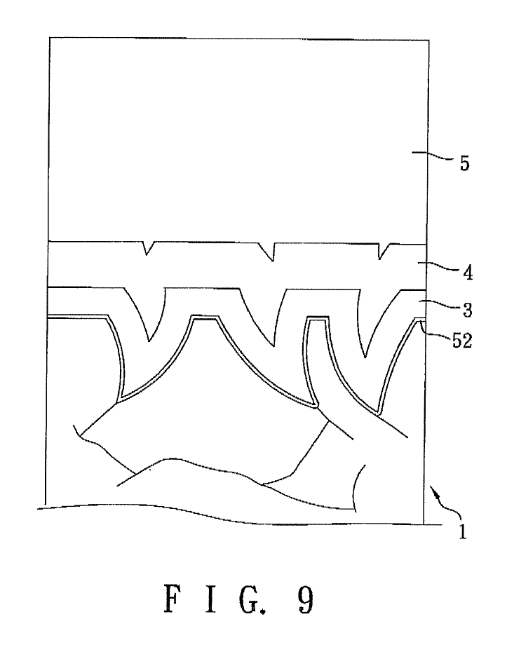

Referring to FIGS. 8 and 9, in another preferred embodiment, a second Ni-based layer 5 is formed on the first Ni-based layer 4 through electroless plating techniques prior to the thermal treating of the assembly of the Mg alloy substrate 1, the transition layer 2 and the first Ni-based layer 4.

More preferably, the second Ni-based layer 5 contains Ni crystals having a face-centered cubic (FCC) structure, NiP alloy having a texture of a body-centered tetragonal (BCT) structure, amorphous Ni, and P doped in grain boundaries of the FCC and BCT structures and the amorphous Ni. More preferably, the formation of the first and second Ni-based layers 4, 5 is controlled in such a manner that the first and second Ni-based layers 4, 5 both extend into the recesses 14 in the Mg alloy substrate 1. Most preferably, the first Ni-based layer 4 has a surface formed with recesses 16, and the second Ni-based layer 5 extends into the recesses 16 in the surface of the first Ni-based layer 4.

In yet another preferred embodiment, the formation of the second Ni-based layer 5 is conducted by applying a second Ni-based layer composition to the first Ni-based layer 4.

In another preferred embodiment, the formation of the second Ni-based layer 5 on the first Ni-based layer 4 is conducted through electroless plating techniques.

More preferably, the second Ni-based layer composition includes water, fluoride ions, ammonium ions, nickel ions, hypophosphite ions, a chelating agent selected from the group consisting of diethylene amine, ethylene diamine, triethylene tetraamine and combinations thereof, and a buffer selected from C2-C8 organic acid ions. More preferably, the C2-C8 organic acid ions are citrate ions.

In one preferred embodiment, the second Ni-based layer composition is maintained at a temperature ranging from 70 to 100° C. and a pH value ranging from 2 to 6.5. The concentrations of the fluoride ions, ammonium ions, nickel ions, hypophosphite ions, the chelating agent and the buffer respectively range from 0.1-5 M, 0.1-5 M, 0.02-2 M, 0.05-1 M, 0.001-0.1 M, and 0.02-2 M. More preferably, the second Ni-based layer composition is maintained at a temperature ranging from 80 to 97° C. and a pH value ranging from 3 to 5, and the concentrations of the fluoride ions, ammonium ions, nickel ions, hypophosphite ions, the chelating agent and the buffer respectively range from 0.35-0.53 M, 0.35-0.53 M, 0.13-0.15 M, 0.1-0.2 M, 0.005-0.01 M, and 0.07-0.1 M. Most preferably, the second Ni-based layer composition is maintained at a temperature ranging from 90 to 95° C. and a pH value ranging from 3.2 to 4.0, and the concentrations of the fluoride ions, ammonium ions, nickel ions, hypophosphite ions, the chelating agent and the buffer respectively range from 0.4-0.5 M, 0.4-0.5 M, 0.135-0.145 M, 0.14-0.16 M, 0.006-0.008 M, and 0.08-0.09 M.

When the most preferred embodiment of the second Ni-based layer composition is applied, the second Ni-based layer 5 has a relatively high phosphorus content due to the relatively low pH value. The presence of phosphorus doped in the second Ni-based layer 5 will reduce the amount of hydrogen doped in the second Ni-based layer 5. Hence, undesired compressive stress resulting from release of hydrogen free radicals from the second Ni-based layer 5 during thermal treatment can be reduced. In addition, after the formation of the first Ni-based layer 4 through electroless plating techniques, numerous crystalline seeds are formed on the surface of the first Ni-based layer 4, which enhances activity of the surface of the first Ni-based layer 4, and density and strength of the second Ni-based layer 5. During the electroless plating process for forming the second Ni-based layer 5, electrons are released due to reaction of the hypophosphite ions and are attached to the surface of the first Ni-based layer 4, which imparts a negative charge on the surface of the first Ni-based layer 4. The cationic chelating agent, such as small molecular amines, chelate with nickel ions in the second Ni-based layer composition, which enhances the migration rate of the chelated Ni compound toward the negative charged surface of the first Ni-based layer 4. In addition, the high migration rate enhances the strength of an internal tensile stress in the second Ni-based layer 5.

Since the Mg alloy substrate 1 has a thermal expansion coefficient ranging from 25 to 30 μm/(m*° C.), and since the second Ni-based layer 5 has a thermal expansion coefficient ranging from 15 to 15 μm/(m*° C.) peeling of the second Ni-based layer 5 from the Mg alloy substrate 1 can occur. However, the relatively high internal tensile stress in the second Ni-based layer 5 is advantageous in preventing the peeling from occurring.

In another preferred embodiment, for the purpose of enhancing the brightness, corrosion resistance and hardness of the surface-treated Mg alloy substrate 1, a third Ni-based layer is formed on the second Ni-based layer 5 through one of electroplating, electroless plating, brush coating, and powder coating techniques. More preferably, the third Ni-based layer contains Ni crystals having a texture of a FCC structure.

In yet another preferred embodiment, the formation of the third Ni-based layer on the second Ni-based layer 5 is conduced by applying a third Ni-based layer composition to the second Ni-based layer 5. The third Ni-based layer composition includes fluoride ions, ammonium ions, nickel ions, and a buffer selected from C2-C8 organic acid ions. More preferably, the buffer is citrate ions.

In another preferred embodiment, the third Ni-based layer composition is maintained at a temperature ranging from 25 to 70° C. and a pH value ranging from 0.5 to 5.0. The concentrations of the fluoride ions, ammonium ions, nickel ions, and the C2-C8 organic acid ions respectively range from 0.1-5 M, 0.1-5 M, 0.1-2 M, and 0.02-2 M. More preferably, the third Ni-based layer composition is maintained at a temperature ranging from 40 to 60° C. and a pH value ranging from 1.5 to 3, and the concentrations of the fluoride ions, ammonium ions, nickel ions, and the C2-C8 organic acid ions respectively range from 1.75-2.1 M, 1.75-2.1 M, 1-1.3 M, and 0.48-0.72 M. Most preferably, the third Ni-based layer composition is maintained at a temperature ranging from 45 to 55° C. and a pH value ranging from 2 to 3, and the concentrations of the fluoride ions, ammonium ions, nickel ions, and the C2-C8 organic acid ions respectively range from 1.8-2 M, 1.8-2 M, 1.1-1.2 M, and 0.56-0.64 M.

In another preferred embodiment, the third nickel-based layer is formed through electroplating techniques under a current density ranging from 1 to 10 A/dm². More preferably, the current density ranges from 2 to 3 A/dm².

In one preferred embodiment, a surface treatment solution according to this invention includes water, fluoride ions, ammonium ions, and nickel ions. Use of the fluoride ions as conductive anions is advantageous in preventing corrosion of the Mg alloy substrate 1. In addition, the fluoride ions have a relatively small ion radius, and relatively high negative electricity and conductivity. The surface treatment solution is suitable for preparing a solution of the transition layer composition, and the first, second and third Ni-based layer compositions. In one preferred embodiment, when the surface treatment solution further contains the M-metal ions selected from the group consisting of zinc ions, cobalt ions, and cadmium ions, the solution thus made is suitable for the solution of the transition layer composition. In another preferred embodiment, when the surface treatment solution further contains hypophosphite ions, and a buffer selected from C2-C8 organic acid ions and the M-metal ions as defined above, the solution thus made is suitable for the solution of the first Ni-based layer composition. In yet another preferred embodiment, when the surface treatment solution further contains hypophosphite ions, a buffer selected from C2-C8 organic acid ions as defined above, the M-metal ions as defined above, and the chelating agent as defined above, the solution thus made is suitable for the solution of the second Ni-based layer composition.

More preferably, the surface treatment solution includes a sulfur-free brightening agent, such as 1,4-butynediol and coumarin, for inhibiting corrosion attributed to sulfur. In addition, the surface treatment solution contains ammonium ions as the chelating agent of the nickel ions so as to enhance the solubility of the nickel fluoride in the surface treatment solution.

The pores in the Mg alloy substrate 1 can be exposed during the cleaning operation of the Mg alloy substrate 1. In one preferred embodiment, the Mg alloy substrate 1 may be chemically polished prior to the formation of the transition layer 3 More preferably, after the chemical polishing operation of the Mg alloy substrate 1, the cleaning operation of the Mg alloy substrate 1 is conducted once again. In another preferred embodiment, the chemical polishing of the Mg alloy substrate 1 is conducted by applying an acidic solution to the magnesium alloy substrate 1. The acidic solution contains fluoride ions, ammonium ions, and nitrate ions. More preferably, the concentrations of the fluoride ions, ammonium ions, and nitrate ions in the acidic solution range from 50-70 cc/L, 30-50 g/L, and 30-50 g/L, respectively. The fluoride ions may be provided by a fluoride source selected from the group consisting of fluoric acid, ammonium fluoride, sodium fluoride, potassium fluoride, and mixtures thereof. Nitrate ions may be provided by a nitrate source selected from the group consisting of nitric acid, ammonium nitrate, sodium nitrate, potassium nitrate, and mixtures thereof. Ammonium ions may be provided by an ammonium source selected from the group consisting of ammonium fluoride, ammonium nitrate, and mixtures thereof. More preferably, the chemical polishing operation of the magnesium alloy substrate 1 is assisted by applying an ultrasonic frequency ranging from 300 to 360 KHz to the cleaning solution. Preferably, the application of the ultrasonic frequency is conducted by harmonic oscillation techniques at a frequency range selected from one of 300 to 360 kHz, 150-180 KHz and 20-45 kHz.

In addition, according to the preferred embodiment of this invention, all the compositions, including the cleaning composition, the chemical polishing composition, the transition layer composition, the first Ni-based layer composition, the second Ni-based layer composition, and the third nickel-based layer composition, used in the preferred embodiment of the method according to this invention include fluoride ions and have similar basic formulations. In the method of this invention, only one washing step is required for the removal of the residues 2. However, numerous washing steps are required by the conventional electroless plating or electroplating process. Hence, the adverse effect on bonding of the magnesium alloy substrate 1 to other articles attributed to the washing steps can be avoided.

Non-limiting examples of the fluoride source for providing fluoride ions in the above compositions according to this invention include fluoric acid, ammonium fluoride, sodium fluoride, potassium fluoride, zinc fluoride, and nickel fluoride, Non-limiting examples of the ammonium source for providing ammonium ions in the above compositions include ammonium fluoride and ammonium hypophosphite. Non-limiting examples of the zinc source for providing the zinc ions in the above compositions include zinc carbonate, zinc hydroxide, zinc fluoride, and zinc hypophosphite. Non-limiting examples of the nickel source for providing the nickel ions in the above compositions include nickel hydroxide, nickel fluoride, nickel citrate arid nickel hypophosphite. Non-limiting examples of the hypophosphite source for providing the hypophosphite ions in the above compositions include hypophosphorous acid, sodium potassium hypophosphite, potassium hypophosphite, and ammonium hypophosphite. Non-limiting examples of the C2-C8 organic acid source for providing C2-C8 organic acid ions include oxalic acid, succinic acid, malic acid, adiapic acid and lactic acid.

It is noted that the source of respective ions is determined according to the effect to which the respective composition is desired to provide. For example, presence of hypophosphite ions, which tend to result in crack down of the electroplating cell, is to be avoided in the transition layer composition Hence, presence of zinc hypophosphite or nickel hypophosphite should be avoided in the transition layer composition. In addition, presence of the M-metal ions such as zinc ions, is to be avoided in the second and third nickel-based layer compositions, and thus, presence of zinc fluoride should be avoided in these compositions.

With respect to the application of the oscillation frequency to the above compositions, it can be conducted through any method known in the art, e.g., applying ultrasounds to a container receiving the above compositions, placing a sonicating probe into the container, or placing the container in an ultrasonator.

### EXAMPLES

### Chemicals Used for the Examples

1. Diethylene triamine: 100% liquid, product no. 111-40-0, commercially available from Aldrich
2. Nickel carbonate: 27% by weight of nickel, product no. 123987 A1, commercially available from Japan Okuno Chemical Industries Co., Ltd.
3. Sodium lauryl sulfonate: product no. 151-21-3, commercially available from Fluka
4. Coumarin: product no. 2543, commercially available from Merck
5. Composition and properties of Magnesium alloy substrates used in the Examples

| Magnesium | Content of | Major doped | Minor doped | |
|---|---|---|---|---|
| alloy | magnesium (wt | metal and its | metal and its | |
| substrate | %) | content (wt %) | content (wt %) | Temper Properties |
| AZ31B | 94.7% | Al (3 wt %) | Zn (1 wt %) | T7, solution |
| | | | | heat treated |
| | | | | and stabilized |
| AZ61A | 91.0% | Al (6 wt %) | Zn (1 wt %) | T7, solution |
| | | | | heat treated |
| | | | | and stabilized |
| ZK60A | 93.6% | Zn (6 wt %) | Zr (0.4 wt %) | T7?, solution? |
| | | | | heat treated |
| | | | | and stabilized |
| LA141A | 83.3% | Li (14 wt %) | Al (1 wt %) | T7, solution |
| | | | | heat treated |
| | | | | and stabilized |
| HM21A | 96.4% | Th (2 wt %) | Mn (1 wt %) | T7, solution |
| | | | | heat treated |
| | | | | and stabilized |
| HK31A | 95% | Th (3 wt %) | Zr (1 wt %) | T7, solution |
| | | | | heat treated |
| | | | | and stabilized |
| EZ33A | 92.1% | Th (3 wt %) | Zn (3 wt %) | T7, solution |
| | | | | heat treated |
| | | | | and stabilized |

### Example 1

Seven LA141A-T7 alloy substrates (made in USA) were respectively designated as Specimens 1 to 7 and surface treated by the method for forming a nickel-based layered structure on a magnesium alloy substrate according to this invention as follows:
(1) A solution of 50 g/L of lactate in isopropanol (1 L) and a solution of 0.5 g/L of sodium lauryl sulfonate in isopropanol (1 L) were prepared at room temperature, and then charged together into a first ultrasonator so as to form a cleaning bath. The seven specimens 1 to 7 were placed in the cleaning bath in the first ultrasonator and cleaned at a frequency of about 330 kHz for 5 minutes. The cleaned specimens 1 to 7 were removed from the first ultrasonator and washed with water.
(2) A chemical polishing solution containing 60 cc/L of fluoric acid, 40 g/L of ammonium fluoride, and 40 g/L of nitric acid was prepared and then charged into a second ultrasonator so as to form a chemical polishing bath. The cleaned specimens 1 to 7 were placed in the chemical polishing bath in the second ultrasonator and chemically polished at a frequency of about 330 kHz for 0.5 minute. The specimens 1 to 7 were removed from the second ultrasonator and then placed in the cleaning bath in the first ultrasonator for another 5 minutes. The specimens 1 to 7 were removed from the first ultrasonator again. A texture of a hexagonal closed-packed (HCP) crystal structure was formed on an outer surface of each specimen, and recesses having a depth ranging from 5 to 10 μm were formed in each specimen at grain boundaries of the HCP crystal structure.
(3) A first surface treatment solution (about pH 0.5) containing water, 15 cc/L of fluoric acid, 40 g/L of ammonium fluoride, 15 g/L of zinc oxide, and 45 g/L of nickel carbonate was prepared and then charged into a third ultrasonator so as to form a transition layer composition bath. The specimens 1 to 7 obtained from the above step (2) were placed in the transition layer composition bath in the third ultrasonator and treated at a frequency of about 330 kHz for 5 minutes. A transition layer containing zinc crystals, nickel crystals, and magnesium fluoride and having a thickness ranging from 5 to 10 nm was formed on each of the specimens 1 to 7.
(4) A second surface treatment solution (about pH 3.5) containing water, 25 g/L of ammonium fluoride, 6 g/L of zinc oxide, 30 g/L of nickel carbonate, 20 g/L of citric acid, and 20 g/L of sodium hypophosphite was prepared so as to form a first nickel-based layer composition bath. The specimens 1 to 7 removed from the transition layer composition bath of the above step (3) were placed in the first nickel-based layer composition bath at about 95° C. for 5 minutes with air agitation. A first nickel-based layer having a thickness ranging from 2 to 3 μm was formed on the transition layer on each of the specimens 1 to 7. The magnesium fluoride formed in step (3) was replaced by the first nickel-based layer and was peeled off from the respective specimen.
(5) A third surface treatment solution (about pH 3.2) containing water, 25 g/L of ammonium fluoride, 1.0 g/L of diethylene triamine, 30 g/L of nickel carbonate, 20 g/L of citric acid, and 20 g/L of sodium hypophosphite was prepared so as to form a second nickel-based layer composition bath. The specimens 1 to 7 removed from the first nickel-based layer composition bath of the above step (4) were placed in the second nickel-based layer composition bath at about 95° C. for 15 minutes with air agitation. A second nickel-based layer having a thickness ranging from 5 to 7 μm was formed on the first nickel-based layer on each of the specimens 1 to 7.
(6) A fourth surface treatment solution (about pH 2.5) containing water, 120 g/L of ammonium fluoride, 250 g/L of nickel carbonates, 150 g/L of citric acid, 10 g/L of 1,4-butynediol, and 2 g/L of coumarin was prepared so as to form a third nickel-based layer composition bath. The specimens 1 to 7 removed from the second nickel-based layer composition bath of the above step (5) were placed in the third nickel-based layer composition bath at about 50° C. under an applied current density of about 2.5 A/dm², for 30 minutes with air agitation. A third nickel-based layer was formed on the second nickel-based layer on each of the specimens 1 to 7.
(7) The specimens 1 to 7 were removed from the third nickel-based layer composition bath of the above step (6), and subsequently heated at a heating rate of about 150° C./hr to about 180° C. in 60 minutes. The specimens 1 to 7 were then maintained at a temperature ranging from 170° C. to 190° C. for 60 minutes, followed by being cooled at a cooling rate of about −150° C./hr to room temperature in 60 minutes The coating including the boundary layer and the first, second and third nickel-based layers formed on each of the specimens 1 to 7 has an average thickness of about 36.5 μm. Each of the specimens 1 to 7 has a cross-sectional structure as shown in FIG. 9, wherein the recesses 14 at the grain boundaries of the HCP crystal structure of each specimen were filled with and closed by the second nickel-based layer 5.

### Structure and Composition of the Coatings on the Specimens 1 to 7

According to analysis of X-ray diffraction, before thermal treatment of the above step (7), each of the specimens 1 to 7 has a zinc to nickel ratio of 10:1 at the interface between the boundary layer and the first nickel-based layer and of 1:9 at the interface between the first and second nickel-based layers, while no absorption peak of specific crystal structure was observed at these two layers since the crystals present in the boundary layer are ultrafine crystals. Both the first and second nickel-based layers contain face-centered cubic nickel, amorphous nickel, and the doped phosphorus present at grain boundaries of face-centered cubic nickel and in the amorphous nickel; while the third nickel-based layer contains face-centered cubic nickel.

After thermal treatment according to the above step (7), a liquid phase of magnesium and zinc was formed at the interface between the transition layer and the respective specimen, and zinc present in the transition layer permeated into the specimen. Consequently, the boundary layer formed after thermal treatment contains a solid solution of magnesium and zinc having a texture of HCP crystal structure, HCP zinc ultrafine crystals, and at least one inter-metallic compound composed of at least two of zinc, nickel and phosphorus. In particular, HCP Zn₉Ni₁ was observed at a bottom portion of the boundary layer adjacent to the respective specimen, and δ phase HCP Zn₅Ni₂₁ was observed at a top portion of the boundary layer adjacent to the first nickel-based layer. Such a phenomenon is so called “Martensitic transformation” behavior, which is favorable to bonding of the coating to the respective specimen.

In addition, after thermal treatment according to the above step (7), the first nickel-based layer has a phosphorus doped amorphous structure containing nickel and zinc; and the second nickel-based layer contains fcc nickel, a bat alloy of nickel and phosphorus, amorphous nickel, and phosphorus doped in the amorphous nickel and in grain boundaries of fcc nickel and the bct alloy of nickel and phosphorus.

### Physical Properties of the Specimens 1 to 7 Formed with the Coatings

The specimens 1 to 7 obtained after surface treatment according to the method of this invention were subjected to the following tests: ASTM D3359, CNS 7094 Z8017, internal stress test, and ASTM B368-61T.

### (1) Bending and Adhesion Test

Each of the specimens 1 to 7 was forced to bend at an angle of 90 degrees. The adhesion strength of the coating on the respective specimen was tested according to ASTM D3359. The results of the test are shown in Table 1. No peeling or detachment of the coating was found for each specimen during the test. Hence, the coating thus formed on each specimen has an excellent bonding strength on the respective specimen.

### (2) Vickers Hardness Tests (CNS 7094 Z8017)

A diamond probe was pressed into the coating on each specimen under a load of 100 g for hardness measurement. The results are expressed in the unit “Hv” and are shown in Table 1.

### (3) Internal Stress Test

Measurement of the internal stress of the coating on each of the specimen was conducted by allowing the coatings to deform solely by the internal stress, followed by applying a force (in a unit of kgf/mm²) that is sufficient to recover the initial shape thereof. A positive value for the applied force is an indication of having a tensile stress, whereas a negative value for the applied force is an indication of having a compressive stress. Results of the internal stress test of each of the specimens 1 to 7 are shown in Table 1, and show that the coating on each specimen exhibits a tensile stress, which can diminish the peeling problem of the coating during thermal expansion and contraction process of the specimens 1 to 7.

### (4) Corrosion Test According to ASTM B368-61T (Copper-Accelerated Acetic Acid Salt Spray (Fog) Test)

The specimens 1 to 7 surface-treated according to the method of this invention were subjected to the corrosion resistance test according to ASTM B368-61T, Results obtained are classified into 10 levels according to Durbin's standard, The higher the level is, the higher will be the corrosion resistance, and the lower will be the porosity of the coating on each specimen. Results of the corrosion resistance test are shown in Table 1. Most of the surface-treated specimens 1 to 7 have corrosion resistance of level 10, indicating that most of the specimens 1 to 7 are endurable to at least 160 hours during the corrosion resistance test.

TABLE 1

| | Corrosion | Corrosion | Bending- | Vickers | Internal |
|---|---|---|---|---|---|
| No. of | resistance | resistance | Adhesion | Hardness | stress |
| Specimen | test (hrs) | level | test | tests | test |
| 1 | 5 | 10 | No peeling | 281 | −16.2 |
| 2 | 10 | 10 | No peeling | 305 | −13.5 |
| 3 | 20 | 10 | No peeling | 293 | −14.5 |
| 4 | 40 | 10 | No peeling | 317 | −11.8 |
| 5 | 80 | 10 | No peeling | 302 | −17.2 |
| 6 | 160 | 10 | No peeling | 308 | −15.6 |
| 7 | 240 | 8 | No peeling | 296 | −14.7 |

### Example 2

Ten LA141A-T7 alloy substrates (made in USA) were respectively designated as Specimens 8 to 17 and were surface treated by the method similar to that of Example 1, except that the third nickel-based layer was formed in hull cell, wherein the high current area has a current density of 5 A/dm²; while the low current area has a current density of 1 A/dm².

### Thickness and Appearance of the Coatings Formed on the Corresponding Specimens 8 to 17

Thickness and appearance of the coating formed on each specimen at the high and low current density areas were determined. The thickness of the coating formed on each specimen was evaluated by using a thickness clamp (available from INOX company, Germany), and appearance of the coating formed on each specimen was evaluated by naked eye. Results of the thickness and appearance of the coating on each specimen are shown in Table 2.

The results shown in Table 2 indicate that the coating on each of the specimens 8 to 17 exhibits bright metal gloss and achieves the required decorating property within a thickness ranging from 20 to 40 μm. In addition, ratio of the coating formed in the high current area to the coating formed in the low current area in layer thickness is relatively small and ranges from 1.4 to 2.2. It indicates that the fluoride ions in the third nickel-based layer composition have excellent conductivity and thus diminish the difference in thickness between the coating formed in the high current area and the coating formed in the low current area.

TABLE 2

| | Average | | Average | Appearance | |
|---|---|---|---|---|---|
| | thickness of | Appearance of | thickness of | of the | |
| | the coating | the coating | the coating | coating | |
| | formed in | formed in the | formed in low | formed in the | |
| No. | high current | high current | current area | low current | |
| of specimen | area (Tₕ, μm) | area | (Tₗ, μm) | area | Tₕ/Tₗ |
| 8 | 40.0 | bright metal | 17.8 | bright metal | 2.2 |
| | | gloss | | gloss | |
| 9 | 42.3 | bright metal | 30.2 | bright metal | 1.4 |
| | | gloss | | gloss | |
| 10 | 37.0 | bright metal | 24.7 | bright metal | 1.5 |
| | | gloss | | gloss | |
| 11 | 37.6 | bright metal | 20.9 | bright metal | 1.8 |
| | | gloss | | gloss | |
| 12 | 38.4 | bright metal | 20.2 | bright metal | 1.9 |
| | | gloss | | gloss | |
| 13 | 43.5 | bright metal | 25.6 | bright metal | 1.7 |
| | | gloss | | gloss | |
| 14 | 35.1 | bright metal | 20.6 | bright metal | 1.7 |
| | | gloss | | gloss | |
| 15 | 38.3 | bright metal | 24.0 | bright metal | 1.6 |
| | | gloss | | gloss | |
| 16 | 43.8 | bright metal | 27.4 | bright metal | 1.6 |
| | | gloss | | gloss | |
| 17 | 41.2 | bright metal | 27.4 | bright metal | 1.5 |
| | | gloss | | gloss | |

### Examples 3 to 8

Specimens of Examples 3 to 8 were prepared. The specification of the specimens is shown in the following Table 3. The specimens were surface treated in a manner similar to that of Example 1. The surface-treated specimens were subjected to the bending-adhesion test and the corrosion test in a manner similar to that of Example 1, and the thickness of the coating formed on the specimen of the respective Examples 3 to 8 was determined. Results of the tests and the thickness measurement are shown in Table 3.

TABLE 3

| | Specification of the | | | |
|---|---|---|---|---|
| | Specimens and its | Thickness of | Corrosion | Bending- |
| No. of | magnesium content | the coating | resistance | Adhesion |
| Example | (wt %) | (μm) | level | test |
| 3 | AZ31B/94.7% | 37.5 | 10 | No peeling |
| 4 | AZ61A/91.0% | 39.0 | 10 | No peeling |
| 5 | ZK60A/93.6% | 39.5 | 10 | No peeling |
| 6 | HM21A/96.4% | 37.0 | 10 | No peeling |
| 7 | HK31A/95% | 36.5 | 10 | No peeling |
| 8 | EZ33A/92.1% | 38.0 | 10 | No peeling |

According to the results shown in Table 3, even if the magnesium alloy substrates have different specifications, the coating including the boundary layer, the first nickel-based layer, the second nickel-based layer and the third nickel-based layer formed on the magnesium alloy substrates according to the method of this invention has a relatively large thickness, as high as 40 μm, and a good adhesion strength to the respective magnesium alloy substrate (i.e., no peeling was found). Therefore, the coating formed on the respective magnesium alloy substrate exhibits excellent corrosion resistance and is able to reach level 10 in the corrosion resistance test.

In view of the foregoing, by forming a boundary layer having a crystal structure similar to a magnesium alloy substrate on the magnesium alloy substrate, other functional layers, such as the first, second and third Ni-based layers, can be firmly formed on the magnesium alloy substrate through the boundary layer so as to improve corrosion resistance of the magnesium alloy substrate.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for forming a nickel (Ni)-based layered structure on a magnesium (Mg) alloy substrate, comprising:
(a) forming a transition layer on the Mg alloy substrate, the transition layer containing Ni crystals and crystals of an M-metal selected from the group consisting of Zn, Co, Cd, and alloys thereof;
(b) forming a first Ni-based layer on the transition layer; and
(c) thermal treating the assembly of the Mg alloy substrate, the transition layer and the first Ni-based layer so as to form a boundary layer containing a solid solution of Mg and the M-metal at an interface between the transition layer and the Mg alloy substrate.

2. The method of claim 1, wherein the M-metal is Zn.

3. The method of claim 1, further comprising cleaning the Mg alloy substrate prior to the formation of the transition layer on the Mg alloy substrate in such a manner to expose a texture of a hexagonal closed-packed (HCP) crystal structure on an outer surface of the Mg alloy substrate.

4. The method of claim 3, wherein the cleaning of the Mg alloy substrate is conducted further in such a manner to form recesses in the Mg alloy substrate at grain boundaries of the HCP crystal structure of the Mg alloy substrate, wherein the formation of the transition layer is conducted in such a manner that the transition layer extends into the recesses in the Mg alloy substrate, and wherein the formation of the first Ni-based layer is conducted in such a manner that the first Ni-based layer extends into the recesses in the Mg alloy substrate.

5. The method of claim 4, wherein the cleaning of the Mg alloy substrate is conducted by applying a cleaning solution to the Mg alloy substrate, the cleaning solution containing an organic acid, an anionic surfactant, and a polar organic solvent.

6. The method of claim 5, wherein the organic acid is selected from the group consisting of lactic acid, acetic acid, oxalic acid, succinic acid, adipic acid, citric acid, malic acid and combinations thereof.

7. The method of claim 6, wherein the organic acid is lactic acid.

8. The method of claim 5, wherein the anionic surfactant is selected from the group consisting of sodium lauryl sulfate, sodium iso-alkyl sulfate, sodium lauryl polyvinylether sulfate, sodium glycerol monolaurate sulfate, polyglycerol esters of interesterified ricinoleic acid sodium salt, sodium lauryl sulfonate, 1,2-alkyl phosphate, and combinations thereof.

9. The method of claim 8, wherein the anionsic surfactant is selected from the group consisting of sodium lauryl sulfonate, 1,2-alkyl phosphate, and combinations thereof.

10. The method of claim 5, wherein the polar solvent is selected from the group consisting of methanol, ethanol, propanol, isopropanol, and combinations thereof.

11. The method of claim 5, wherein concentrations of the organic acid and the anionic surfactant in the cleaning solution range from 0.1 to 2 M and 0.001 to 0.01 M, respectively.

12. The method of claim 5, wherein the concentrations of the organic acid and the anionic surfactant in the cleaning solution range from 0.4 to 0.7 M and 0.002 to 0.04 M, respectively.

13. The method of claim 5, wherein the cleaning of the Mg alloy substrate is conducted by further using a washing solvent to remove residues resulting from reaction between the cleaning solution and the Mg alloy substrate.

14. The method of claim 13, wherein the washing solvent is selected from the group consisting of water and an alcohol having a carbon number less than 4.

15. The method of claim 14, wherein the washing solvent is water.

16. The method of claim 13, wherein the removal of the residues is assisted by applying an ultrasonic frequency ranging from 300 to 360 kHz to the washing solvent.

17. The method of claim 16, wherein the application of the ultrasonic frequency is conducted by harmonic oscillation techniques at a frequency range selected from one of 300 to 360 kHz, 150-180 kHz and 20-45 kHz.

18. The method of claim 5, wherein the cleaning of the Mg alloy substrate is assisted by applying an ultrasonic frequency ranging from 300 to 360 kHz to the cleaning solution.

19. The method of claim 18, wherein the application of the ultrasonic frequency is conducted by harmonic oscillation techniques at a frequency range selected from one of 300 to 360 kHz, 150-180 kHz and 20-45 kHz.

20. The method of claim 1, wherein the formation of the transition layer is conducted by applying a transition layer composition to the Mg alloy substrate, the transition layer composition including water, fluoride ions, ammonium ions, the M-metal ions, and nickel ions.

21. The method of claim 20, wherein the formation of the transition layer is assisted by applying an oscillation frequency ranging from 300 to 360 KHz to the transition layer solution.

22. The method of claim 21, wherein the application of the ultrasonic frequency is conducted by harmonic oscillation techniques at a frequency range selected from one of 300 to 360 kHz, 150-180 KHz and 20-45 kHz.

23. The method of claim 20, wherein the M-metal ions are zinc ions.

24. The method of claim 23, wherein the transition layer composition is maintained at a temperature ranging from 0 to 85° C. and a pH value ranging from 0.1 to 2, the concentrations of the fluoride ions, ammonium ions, zinc ions, and nickel ions of the transition layer composition respectively ranging from 0.1-5 M, 0.1-5 M, 0.02-2 M, and 0.05-2 M.

25. The method of claim 23, wherein the transition layer composition is maintained at a temperature ranging from 0 to 30° C. and a pH value ranging from 0.2 to 1.5, the concentrations of the fluoride ions, ammonium ions, zinc ions, and nickel ions of the transition layer composition respectively ranging from 0.7-1.4 M, 0.5-0.9 M, 0.12-0.25 M, and 0.2-0.25 M.

26. The method of claim 20, wherein the transition layer further includes magnesium fluoride (MgF₂).

27. The method of claim 1, wherein the first Ni-based layer contains Ni and the M-metal as major components and phosphorus (P) as a dopant.

28. The method of claim 27, wherein the formation of the first Ni-based layer is conducted by applying a first Ni-based layer composition to the transition layer, the first Ni-based layer composition including water, fluoride ions, ammonium ions, the M-metal ions, nickel ions, hypophosphite ions, and a buffer selected from C2-C8 organic acid ions.

29. The method of claim 28, wherein the M-metal ions are zinc ions.

30. The method of claim 29, wherein the first Ni-based layer composition is maintained at a temperature ranging from 70 to 100° C. and has a pH value ranging from 2 to 6.5, the concentrations of the fluoride ions, ammonium ions, zinc ions, nickel ions, hypophosphite ions, and C2-C8 organic acid ions of the Ni-based layer composition respectively ranging from 0.1-5 M, 0.1-5 M, 0.02-2 M, 0.02-2 M, 0.05-1 M, and 0.02-2 M.

31. The method of claim 29, wherein the first Ni-based layer composition is maintained at a temperature ranging from 80 to 97° C. and has a pH value ranging from 3 to 4.5, the concentrations of the fluoride ions, ammonium ions, zinc ions, nickel ions, hypophosphite ions, and C2-C8 organic acid ions of the Ni-based layer composition respectively ranging from 0.35-0.53 M, 0.35-0.53 M, 0.06-0.09 M, 0.127-0.155 M, 0.1-0.2 M, and 0.07-0.1 M.

32. The method of claim 4, wherein the formation of the first Ni-based layer is controlled so as to partially fill up the recesses in the Mg alloy substrate.

33. The method of claim 1, wherein the formation of the first Ni-based layer is conducted through electroless plating techniques.

34. The method of claim 1, wherein the thermal treating of the assembly of the Mg alloy substrate, the transition layer, and the first Ni-based layer is conducted at a temperature ranging from 140° C. to 250° C.

35. The method of claim 34, wherein the temperature conducted during the thermal treating ranges from 170° C. to 190° C.

36. The method of claim 1, further comprising forming a second Ni-based layer on the first Ni-based layer through electroless plating techniques prior to the thermal treating of the assembly of the Mg alloy substrate, the transition layer and the first Ni-based layer.

37. The method of claim 36, wherein the formation of the second Ni-based layer is conducted by applying a second Ni-based layer composition to the first Ni-based layer, the second Ni-based layer composition including water, fluoride ions, ammonium ions, nickel ions, hypophosphite ions, a chelating agent selected from the group consisting of diethylene amine, ethylene diamine, triethylene tetraamine and combinations thereof, and a buffer selected from C2-C8 organic acid ions.

38. The method of claim 37, wherein the C2-C8 organic acid ions are citrate ions.

39. The method of claim 37, wherein the second Ni-based layer composition is maintained at a temperature ranging from 70 to 100° C. and has a pH value ranging from 2 to 6.5, the concentrations of the fluoride ions, ammonium ions, nickel ions, hypophosphite ions, the chelating agent and the buffer of the second Ni-based layer composition respectively ranging from 0.1-5 M, 0.1-5 M, 0.02-2 M, 0.05-1 M, 0.001-0.1 M, and 0.02-2 M.

40. The method of claim 37, wherein the second Ni-based layer composition is maintained at a temperature ranging from 80 to 97° C. and has a pH value ranging from 3 to 5, the concentrations of the fluoride ions, ammonium ions, nickel ions, hypophosphite ions, the chelating agent and the buffer of the second Ni-based layer composition respectively ranging from 0.35-0.53 M, 0.35-0.53 M, 0.13-0.15 M, 0.1-0.2 M, 0.005-0.01 M, and 0.07-0.1 M.

41. The method of claim 4, further comprising forming a second Ni-based layer on the first Ni-based layer through electroless plating techniques prior to the thermal treating of the assembly of the Mg alloy substrate, the transition layer and the first Ni-based layer.

42. The method of claim 41, wherein the formation of the first and second Ni-based layers is controlled in such a manner that the first and second Ni-based layers both extend into the recesses in the Mg alloy substrate.

43. The method of claim 36, further comprising forming a third Ni-based layer on the second Ni-based layer through one of electroplating, electroless plating, brush coating, and powder coating techniques prior to the thermal treating of the assembly of the Mg alloy substrate, the transition layer, and the first Ni-based layer.

44. The method of claim 43, wherein the formation of the third Ni-based layer on the second Ni-based layer is conduced by applying a third Ni-based layer composition to the second Ni-based layer, the third Ni-based layer composition including fluoride ions, ammonium ions, nickel ions, and a buffer selected from C2-C8 organic acid ions.

45. The method of claim 44, wherein the buffer is citrate ions.

46. The method of claim 44, wherein the third Ni-based layer composition is maintained at a temperature ranging from 25 to 70° C. and has a pH value ranging from 0.5 to 5.0, the concentrations of the fluoride ions, ammonium ions, nickel ions, and the C2-C8 organic acid ions of the third Ni-based layer composition respectively ranging from 0.1-5 M, 0.1-5 M, 0.1-2 M, and 0.02-2 M.

47. The method of claim 44, wherein the third Ni-based layer composition is maintained at a temperature ranging from 40 to 60° C. and has a pH value ranging from 1.5 to 3, the concentrations of the fluoride ions, ammonium ions, nickel ions, and the C2-C8 organic acid ions of the third Ni-based layer composition respectively ranging from 1.75-2.1 M, 1.75-2.1 M, 1-1.3 M, and 0.48-0.72 M.

48. The method of claim 1, further comprising chemically polishing the Mg alloy substrate prior to the formation of the transition layer.

49. The method of claim 48, wherein the chemical polishing of the Mg alloy substrate is conducted by applying an acidic solution to the Mg alloy substrate, the acidic solution including fluoride ions, ammonium ions, and nitrate ions.

50. A surface-treated magnesium (Mg) alloy article comprising:
a Mg alloy substrate;
a boundary layer of a solid solution of Mg and an M-metal selected from the group consisting of Zn, Co, Cd and alloys thereof formed on said Mg alloy substrate; and
a first Ni-based layer formed on said boundary layer.

51. The surface-treated magnesium alloy article of claim 50, wherein said boundary layer of the solid solution of Mg and the M-metal further includes an inter-metallic compound of at least two of the M-metal, Ni, and phosphorus (P); and wherein the first Ni-based layer contains Ni and the M-metal as major components and P as a dopant.

52. The surface-treated magnesium alloy article of claim 50, wherein the concentration ratio of Ni to said M-metal in said boundary layer along the layer thickness of said boundary layer is gradually increased from an interface between said boundary layer and said Mg alloy substrate to an interface between said boundary layer and said first Ni-based layer.

53. The surface-treated magnesium alloy article of claim 50, wherein said M-metal is Zn.

54. The surface-treated magnesium alloy article of claim 53, wherein said boundary layer further contains a solid solution of Ni₅Zn₂₁ disposed adjacent to said first Ni-based layer.

55. The surface-treated magnesium alloy article of claim 50, wherein said Mg alloy substrate has a texture of a hexagonal closed-packed structure and formed with a plurality of recesses at grain boundaries of the hexagonal closed-packed structure, said boundary layer and said first Ni-based layer extending into said recesses in said Mg alloy substrate.

56. The surface-treated magnesium alloy article of claim 50, wherein said first Ni-based layer is amorphous, and contains Ni, said M-metal, and P.

57. The surface-treated magnesium alloy article of claim 50, wherein said boundary layer has a thickness not less than 20 nm.

58. The surface-treated magnesium alloy article of claim 50, further comprising a second Ni-based layer formed on said first Ni-based layer.

59. The surface-treated magnesium alloy article of claim 58, wherein said second Ni-based layer contains Ni crystals having a texture of a face-centered cubic (FCC) structure, NiP alloy having a texture of a body-centered tetragonal (BCT) structure, amorphous Ni, and P doped in grain boundaries of the FCC and BCT structures and the amorphous Ni.

60. The surface-treated magnesium alloy article of claim 58, wherein said first Ni-based layer has a surface and recesses indented from the surface and wherein said second Ni-based layer extends into said recesses in said first Ni-based layer.

61. The surface-treated magnesium alloy article of claim 58, further comprising a third Ni-based layer formed on said second Ni-based layer, said third Ni-based layer containing Ni crystals having a texture of a FCC structure.

62. The surface-treated magnesium alloy article of claim 50, wherein said boundary layer contains ultrafine crystals of the M-metal having a texture of HCP structure.

63. A cleaning solution useful for treating a surface of a magnesium alloy article, comprising an organic acid selected from the group consisting of lactic acid, acetic acid, oxalic acid, succinic acid, adipic acid, citric acid, malic acid and combinations thereof; an anionic surfactant; and a polar organic solvent.

64. The cleaning solution of claim 63, wherein the organic acid is lactic acid.

65. The cleaning solution of claim 63, wherein the anionic surfactant is selected from the group consisting of sodium lauryl sulfate, sodium iso-alkyl sulfate, sodium lauryl polyvinylether sulfate, sodium glycerol monolaurate sulfate, polyglycerol esters of interesterified ricinoleic acid sodium salt, sodium lauryl sulfonate, 1,2-alkyl phosphate, and combinations thereof.

66. The cleaning solution of claim 65, wherein the anionic surfactant is selected from the group consisting of sodium lauryl sulfonate, 1,2-alkyl phosphate, and combinations thereof.

67. The cleaning solution of claim 63, wherein the polar solvent is selected from the group consisting of methanol, ethanol, propanol, isopropanol, and combinations thereof.

68. The cleaning solution of claim 63, wherein concentrations of the organic acid and the anionic surfactant in the cleaning solution range from 0.1 to 2 M and 0.001 to 0.01 M, respectively.

69. The cleaning solution of claim 63, wherein the concentrations of the organic acid and the anionic surfactant in the cleaning solution range from 0.4 to 0.7 M and 0.002 to 0.04 M, respectively.

70. A surface treatment solution comprising water, fluoride ions, ammonium ions, and nickel ions.

71. The surface treatment solution of claim 70, further comprising M-metal ions selected from the group consisting of zinc ions, cobalt ions, and cadmium ions.

72. The surface treatment solution of claim 71, wherein the M-metal ions are zinc ions.

73. The surface treatment solution of claim 72, wherein the composition of the surface treatment solution has a pH value ranging from 0.1 to 2 and wherein the concentrations of fluoride ions, ammonium ions, zinc ions, and nickel ions of the surface treatment solution are respectively 0.1-5 M, 0.1-5 M, 0.02-2 M, and 0.05-2 M.

74. The surface treatment solution of claim 72, wherein the composition of the surface treatment solution has a pH value ranging from 0.2 to 1.5 and wherein the concentrations of fluoride ions, ammonium ions, zinc ions, and nickel ions of the surface treatment solution are respectively 0.7-1.4 M, 0.5-0.9 M, 0.12-0.25 M, and 0.2-0.25 M.

75. The surface treatment solution of claim 71, further comprising hypophosphite ions and a buffer selected from C2-C8 organic acid ions.

76. The surface treatment solution of claim 75, wherein the buffer is citrate ions.

77. The surface treatment solution of claim 72, further comprising hypophosphite ions and a buffer selected from C2-C8 organic acid ions.

78. The surface treatment solution of claim 77, wherein the composition of the surface treatment solution has a pH value ranging from 2 to 6.5, and the concentrations of the fluoride ions, ammonium ions, zinc ions, nickel ions, hypophosphite ions, and C2-C8 organic acid ions of the surface treatment solution respectively ranging from 0.1-5 M, 0.1-5 M, 0.02-2 M, 0.02-2 M, 0.05-1 M, and 0.02-2 M.

79. The surface treatment solution of claim 77, wherein the composition of the surface treatment solution has a pH value ranging from 3 to 4.5, the concentrations of the fluoride ions, ammonium ions, zinc ions, nickel ions, hypophosphite ions, and C2-C8 organic acid ions of the surface treatment solution respectively ranging from 0.35-0.53 M, 0.35-0.53 M, 0.06-0.09 M, 0.127-0.155 M, 0.1-0.2 M, and 0.07-0.1 M.

80. The surface treatment solution of claim 70, further comprising hypophosphite ions, a buffer selected from C2-C8 organic acid ions, and a chelating agent selected from the group consisting of diethylene triamine, ethylene diamine, triethylene tetraamine, and combinations thereof.

81. The surface treatment solution of claim 80, wherein the composition of the surface treatment solution has a pH value ranging from 2 to 6.5, the concentrations of the fluoride ions, ammonium ions, nickel ions, hypophosphite ions, the chelating agent, and the organic acid ions of the surface treatment solution respectively ranging from 0.1-5 M, 0.1-5 M, 0.02-2 M, 0.05-1 M, 0.001-0.1 M, and 0.02-2 M.
